(19) United States
(12) Patent Application Publication
(10) Pub. No.: US 2002/0020980 A1
(43) Pub. Date: Feb. 21, 2002

(54) Folding collapsible kick scooter

(76) Inventor: Cheng-Liang Lee, Hsi-Chin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/846,417

(22) Filed: May 2, 2001

(30) Foreign Application Priority Data
May 25, 2000 (TW) 89208912

(51) Int. Cl. B62M 1/00; B62B 3/02

(52) U.S. Cl. 280/87.041; 280/87.05; 280/655.1

(57) ABSTRACT

A folding collapsible kick scooter includes a footplate holding a rear wheel, a spring-supported rear brake unit installed in the rear side of the footplate and adapted to stop the rear wheel from rotation, a handlebar and front fork assembly coupled to the front side of the footplate and holding a front wheel, a folding structure coupled between the handlebar and front fork assembly and the footplate and adapted to lock the handlebar and front fork assembly between an extended position and a collapsed position, the handlebar and front fork assembly having a detachable handlebar unit controlled by a press-control locking device to lock/unlock handgrips.

### BACKGROUND OF THE INVENTION

The present invention relates to a kick scooter and, more particularly, to a folding collapsible kick scooter, which is durable and safe in use.

The handlebar of a regular kick scooter is an integrated member made of a steel pipe and covered with two rubber handgrips for the holding of the hands. There are also known kick scooters with a detachable handlebar structure. This detachable handlebar structure is comprised of a handlebar stem, and two handgrips detachably fastened to the handlebar stem by screws. When disconnecting the handgrips from the handlebar stem, a screwdriver must be used to remove the screws from the handgrips and the handlebar stem. Further, in order to save storage space, regular kick scooters are commonly made folding collapsible. The folding structure of a conventional folding collapsible kick scooter is generally comprised of a locating frame fixedly fastened to the front side of the footplate, a coupling frame extended from the head tube of the kick scooter and pivoted to the locating frame by a pivot, and a spring-supported locking rod adapted to lock the coupling frame between the extended position and the collapsed position. Simply using a spring-supported locking rod to lock the coupling frame is not safe. When the parts of the kick scooter start to wear after long uses, the spring-supported locking rod can no long lock the coupling frame positively in position. Regular kick scooters commonly have a brake means for stopping the kick scooter from movement. The brake means can be a hand brake, or a foot brake. A hand brake is complicated and expensive. A regular foot brake for kick scooter is integral with the rear fender. When the rider presses the rear fender with the foot, the foot brake is forced against the periphery of the rear wheel to stop the rear wheel from rotation. Because the rear fender is backwardly extended from the rear side of the footplate, the rider must turn the leg backwards through a certain angle and then press the foot on the rear fender when stopping the kick scooter. To a young kick scooter rider, it is dangerous to turn the leg backwards through a big angle to touch the rear fender far away from the center area of the footplate.

### SUMMARY OF THE INVENTION

The present invention has been accomplished to provide a folding collapsible kick scooter, which eliminates the aforesaid drawbacks. According to one aspect of the present invention, the folding collapsible kick scooter comprises a footplate holding a rear wheel, a spring-supported rear brake unit installed in the rear side of the footplate and adapted to stop the rear wheel from rotation, a handlebar and front fork assembly coupled to the front side of the footplate and holding a front wheel, a folding structure coupled between the handlebar and front fork assembly and the footplate and adapted to lock the handlebar and front fork assembly between an extended position and a collapsed position, the handlebar and front fork assembly having a detachable handlebar unit controlled by a press-control locking device to lock/unlock handgrips. According to another aspect of the present invention, the press-control locking device is supported on a compression spring, and forced by the compression spring to lock the handgrips automatically. According to another aspect of the present invention, the handgrips are unlocked when pressing down the press-control locking device with the hand. According to still another aspect of the present invention, the folding structure comprises a hollow locating frame fixedly fastened to the front side of the footplate, a coupling frame coupled between the hollow locating frame and the handlebar and front fork assembly, and two lock means controlled to lock/unlock the coupling frame. The coupling frame comprises a head tube coupled to the handlebar and front fork assembly, and a coupling bar extended from the head tube and inserted into the hollow locating frame and surrounded by the four peripheral walls of the hollow locating frame. According to still another aspect of the present invention, the foot brake is pivoted to a rear wheel brake at the rear side of the footplate in front of the rear wheel, and supported on a spring member for pressing by the foot to stop the rear wheel from rotation.

### BRIEF DESCRIPTION OF THE DRAWINGS

FIG. 1 is an exploded view of a detachable handlebar unit for a folding collapsible kick scooter according to the present invention.

FIG. 2 is an exploded view of a folding structure for a folding collapsible kick scooter according to the present invention.

FIG. 3 is an exploded view of a rear brake unit for a folding collapsible kick scooter according to the present invention.

FIG. 4 is a schematic drawing showing the handlebar and front fork assembly of the folding collapsible kick scooter turned between the vertical position and the horizontal position according to the present invention.

FIG. 5 is an elevational view of the folding collapsible kick scooter according to the present invention.

### DETAILED DESCRIPTION OF THE PREFERRED EMBODIMENT

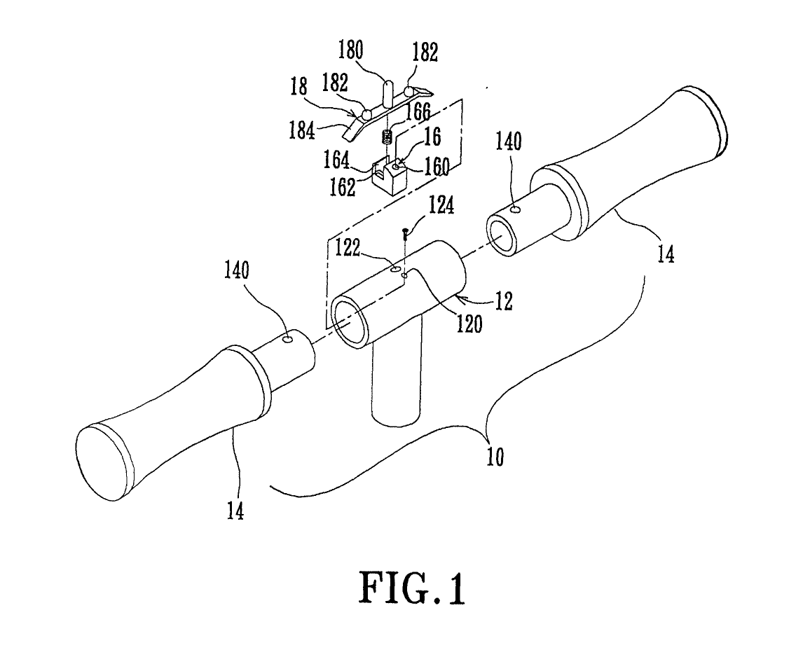

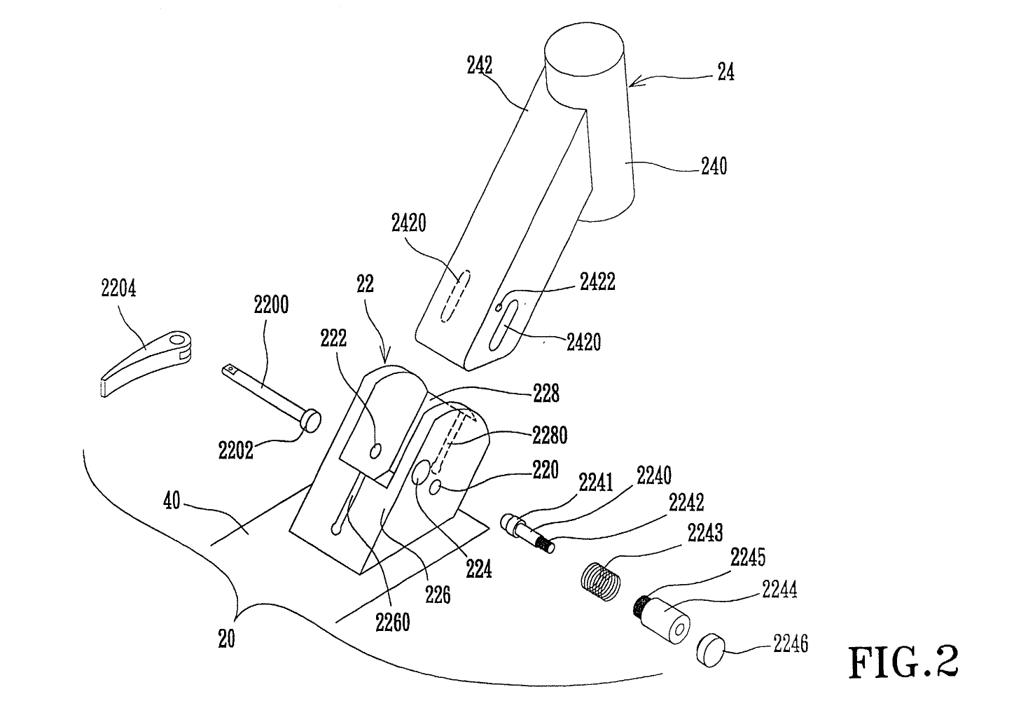

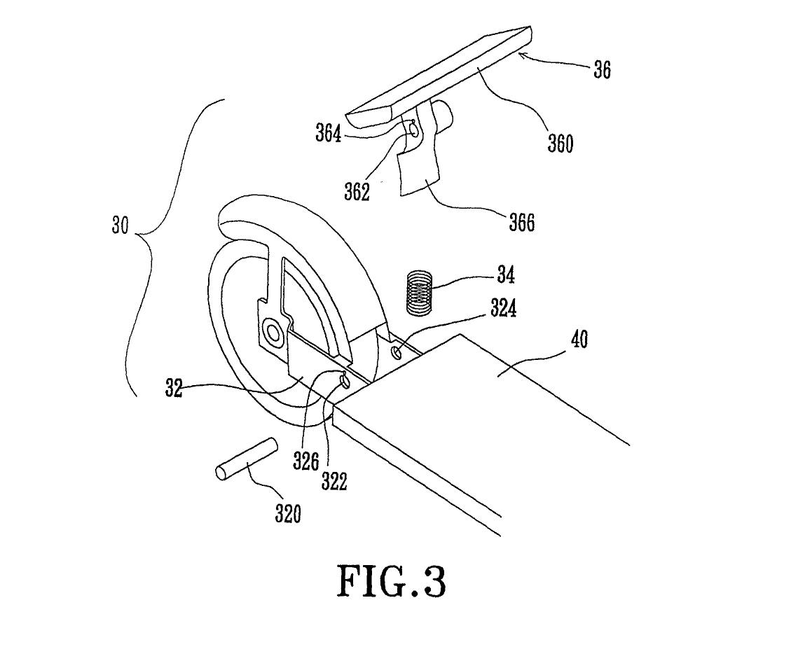

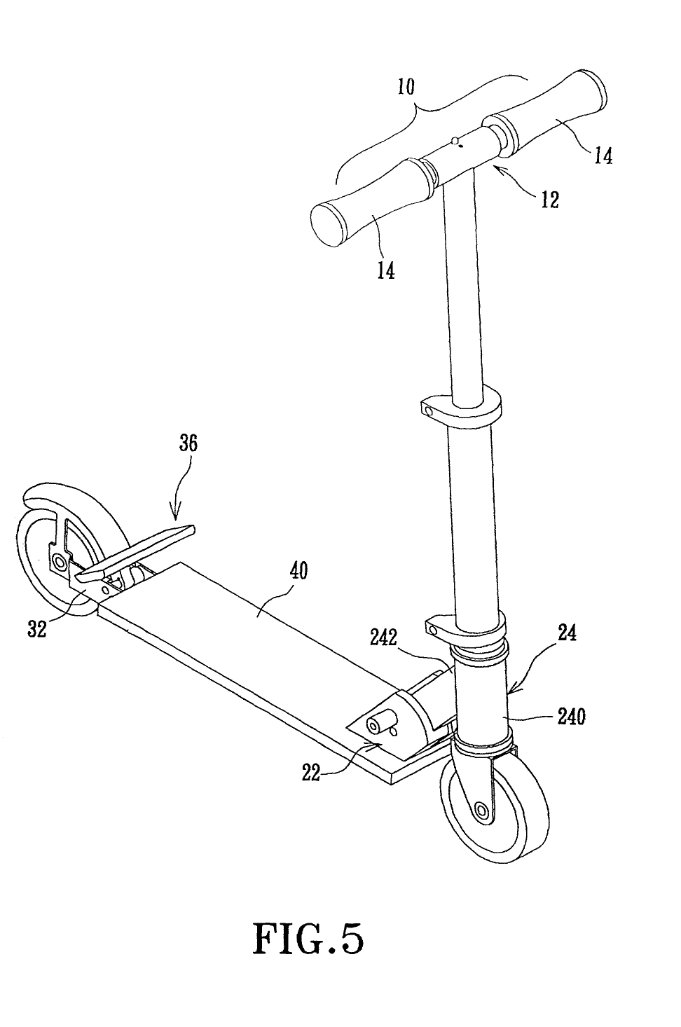

Referring to FIG. 5, a folding collapsible kick scooter in accordance with the present invention comprises a detachable handlebar unit 10 (see also FIG. 1), a folding structure 20 (see also FIG. 2), and a rear brake unit 30 (see also FIG. 3).

Referring to FIGS. 1 and 5, the detachable handlebar unit 10 comprises a T-shaped handlebar stem 12 formed of a T-tube, two handgrips 14, a locating block 16, a spring member 166, and a press-control locking device 18. The T-shaped handlebar stem 12 comprises a top screw hole 120 and a top button hole 122. The handgrips 14 each comprise a locating hole 140 radially disposed at the respective tubular front extension end. The locating block 16 comprises a top screw hole 160, a transversely extended top groove 164, and a blind hole 162 disposed in the top groove 164. The press-control locking device 18 comprises an upright press rod 180 on the middle, two guide slopes 184 disposed at two distal ends thereof and respectively sloping downwardly outwards, and two upright short locating rods 182 bilaterally spaced between the guide slopes 184 and the upright press rod 180. The upright press rod 180 is much longer than the upright short locating rods 182. The press-control locking device 18 is attached to the top groove 164 of the locating block 16 and inserted with the locating block 16 and the spring member 166 into the horizontal top section of the T-shaped handlebar stem 12, keeping the spring member 166 positioned in the blind hole 162 and stopped between the locating block 16 and the press-control locking device 18. After insertion of the press-control locking device 18 with the spring member 166 and the locating block 16 into the handlebar stem 12, the upright press rod 180 of the press-control locking device 18 is extended out of the handlebar stem 12 through the top button hole 122, and a screw 124 is threaded into the top screw hole 120 of the handlebar stem 12 and the top screw hole 160 of the locating block 16 to fixedly secure the locating block 16 to the inside of the handlebar stem 12. Before inserting the tubular front extension end of each handgrip 14 into the horizontal top section of the T-shaped handlebar stem 12, the pressing the upright press rod 180 is depressed to lower the upright short locating rods 182. After insertion of the tubular front extension end of each handgrip 14 into the two distal ends of the horizontal top section of the T-shaped handlebar stem 12, the hand is released from the press-control locking device 18, enabling the press-control locking device 18 to be pushed upwards by the spring member 166 to force the upright short locating rods 182 into the locating hole 140 of each handgrip 14 respectively, and therefore the handgrips 14 are locked. When pressing down the upright press rod 180, the upright short locating rods 182 are respectively disengaged from the locating hole 140 of each handgrip 14, enabling the handgrips 14 to be removed from the handlebar stem 12.

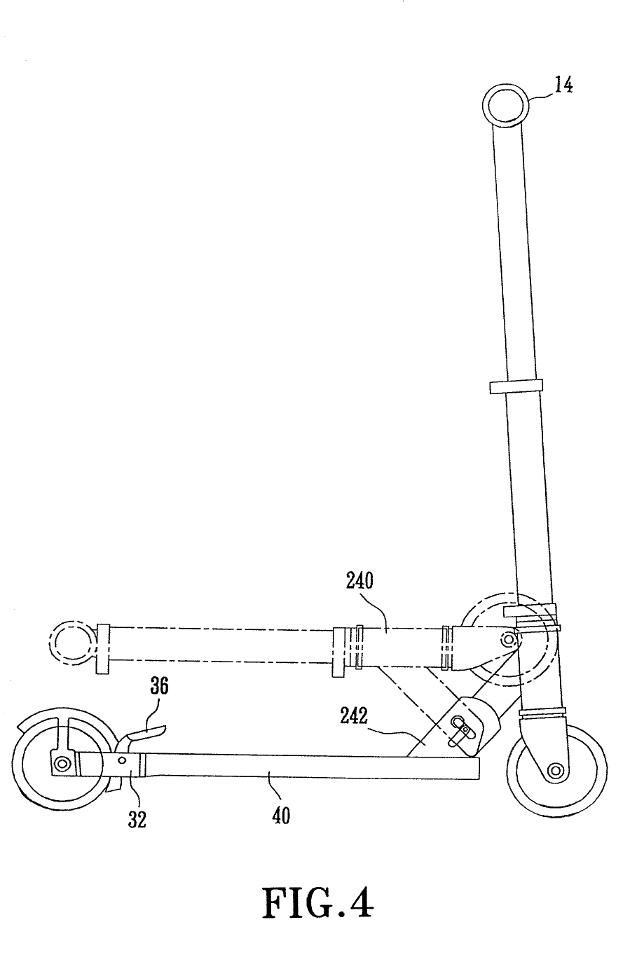

Referring to FIGS. 2, 4 and 5, the folding structure 20 comprises a hollow locating frame 22 fixedly connected to the kick scooter's footplate 40 at the front side, a coupling frame 24 coupled between the handlebar and front fork assembly of the kick scooter and the locating frame 22. The locating frame 22 comprises two pivot holes 220 and 222 respectively disposed at two opposite lateral sidewalls thereof, a screw hole 224 disposed at one lateral sidewall, a split front sidewall 226 having a longitudinal split 2260, and a split rear sidewall 228 having a longitudinal split 2280. The coupling frame 24 comprises a head tube 240, and a hollow coupling bar 242 obliquely downwardly extended from the periphery of the head tube 240. The split front sidewall 226 is relatively lower (shorter) than the split rear sidewall 228 and the two opposite lateral sidewalls of the locating frame 22. The coupling bar 242 is shaped like a channel bar, comprising two longitudinal sliding slots 2420 respectively disposed at two opposite sidewalls thereof, and a locating hole 2422 disposed at one sidewall adjacent to the corresponding sliding slot 2420. The coupling bar 242 is inserted into the hollow locating frame 22 and pivotally connected thereto. A headed pivot pin 2200 is inserted through the pivot holes 220 and 222 of the locating frame 22 and the sliding slots 2420 of the coupling bar 242 to pivotally secure the coupling bar 242 to the locating frame 22, having a head 2202 disposed outside the locating frame 22 and stopped at an outer surface of one lateral sidewall of the locating frame 22. A locking lever 2204 is pivoted to one end of the pivot pin 2200 remote from the head 2202 and stopped at the outer surface of one lateral sidewall of the locating frame 22. A barrel 2244 is provided having a threaded neck 2245 threaded into the screw hole 224 of the locating frame 22. A locking rod 2240 is inserted through the barrel 2244 and engaged into the locating hole 2422 of the coupling bar 242 to lock the coupling frame 24, having an outer thread 2242 at one end thereof and a flange 2241 around the periphery. A compression spring 2243 is sleeved onto the locking rod 2240 and stopped between the flange 2241 of the locking rod 2240 and the inner surface of one lateral sidewall of the locating frame 22. A cap nut 2246 is threaded onto the outer thread 2242 of the locking rod 2240 and stopped at one end of the barrel 2244 remote from the threaded neck 2245. The compression spring 2243 imparts a forward pressure to the locking rod 2240, keeping the locking rod 2240 in the engaged position in the locating hole 2422 of the coupling bar 242. When collapsing the folding structure 20, the locking lever 2204 is turned outwards from the locking position where the locking lever 2204 is closely attached to one lateral sidewall of the locating frame 22 to the unlocking position where the locking lever 2204 is disposed substantially perpendicular to the locating frame 22, and then the cap nut 2246 is pulled outwards to disengage the locking rod 2240 from the locating hole 2422 of the coupling bar 242, and then the coupling bar 242 is pulled upwardly outwards from the locating frame 22 and released from the constraint of the split front sidewall 226, and then the coupling frame 24 is turned with the handlebar and front fork assembly of the kick scooter from the vertical position to the horizontal position (see FIG. 4). When collapsed, the cap nut 2246 is released from the hand, and the compression spring 2243 forces the locking rod 2240 into one sliding slot 2420 of the coupling bar 242, and the locking lever 2204 is returned from the unlocking position to the locking position, and thus the coupling frame 24 is locked in the horizontal (collapsed) position. Further, when turning the locking lever 2204 from the unlocking position to the locking position, the two opposite lateral sidewalls of the locating frame 22 are squeezed toward each other against the two opposite sidewalls of the coupling bar 242 to force the split front sidewall 226 and the split rear sidewall 228 to close the splits 2260 and 2280. On the contrary, when turning the locking lever 2204 from the locking position to the unlocking position, the two opposite lateral sidewalls of the locating frame 22 are released from the two opposite sidewalls of the coupling bar 242, and the split front sidewall 226 and the split rear sidewall 228 are released from the pressure of the two opposite lateral sidewalls of the locating frame 22.

Referring to FIG. 3, the rear brake unit 30 comprises a rear wheel bracket 32, a foot brake 36, a pivot 320, and a spring member 34. The rear wheel bracket 32 is fixedly provided at the rear side of the footplate 40, comprising two pivot holes 322 and 324 aligned at two sides, and a recessed hole 326 disposed at one side of one pivot hole 322. The foot brake 36 comprises a pedal 360, a brake shoe 366, a transverse pivot hole 362 spaced between the pedal 360 and the brake shoe 366, and a recessed hole 364 disposed at one side adjacent to the pivot hole 362. The pivot 320 is mounted in the pivot holes 322 and 324 of the rear wheel bracket 32 and the pivot hole 362 of the foot brake 36 to pivotally secure the foot brake 36 to the rear wheel bracket 32. The spring member 34 is mounted on the pivot 320 and connected between the recessed hole 326 of the rear wheel bracket 32 and the recessed hole 364 of the foot brake 36 to hold the foot brake 36 in the non-braking position where the brake shoe 366 is spaced from the periphery of the kick scooter's rear wheel. When the user steps on the pedal 360, the foot brake 36 is turned about the pivot 320 through an angle to overcome the spring power of the spring member 34 and to force the brake shoe 366 against the periphery of the kick scooter's rear wheel, and therefore the kick scooter is stopped. When releasing the foot from the foot brake 36, the spring member 34 immediately returns the foot brake 36 to its former position, for enabling the rear wheel to be freely rotated.

While only one embodiment of the present invention has been shown and described, it will be understood that various modifications and changes could be made thereunto without departing from the spirit and scope of the invention disclosed.

What the invention claimed is:

1. A folding collapsible kick scooter comprising a footplate, said footplate having a front side and a rear side, a rear wheel coupled to the rear side of said footplate, a rear brake unit installed in the rear side of said footplate and adapted to stop said rear wheel from rotation, a handlebar and front fork assembly coupled to the front side of said footplate and holding a front wheel, a folding structure coupled between said handlebar and front fork assembly and said footplate, said handlebar and front fork assembly comprising a detachable handlebar unit, wherein said detachable handlebar unit comprises:
a T-shaped handlebar stem formed of a T-tube, said T-shaped handlebar stem comprising a top screw hole and a top button hole;
two handgrips respectively detachably fastened to said T-shaped handlebar stem at two sides, said handgrips each comprising a locating hole;
a locating block fixedly fastened to the inside of said T-shaped handlebar stem, said locating block comprising a top screw hole fixedly connected to the top screw hole of said T-shaped handlebar stem by a screw, a transversely extended top groove, and a blind hole disposed in said top groove;
a press-control locking device mounted in the top groove of said locating block inside said T-shaped handlebar stem and controlled to lock/unlock said handgrips, said press-control locking device comprising an upright press rod extended out of the top button hole of said T-shaped handlebar stem for pressing by hand, and two upright short locating rods adapted for engaging the locating hole of each of said handgrips to lock said handgrips; and
spring means mounted in the blind hole of said locating block and supported between said locating block and said press-control locking device to impart an upward pressure to said press-control locking device and to force the upright short locating rods of said press-control locking device into the locating hole of each of said handgrips.

2. The folding collapsible kick scooter of claim 1 wherein said press-control locking device comprises two guide slopes disposed at two distal ends thereof and adapted to guide said handgrips in and out of said T-shaped handlebar stem.

3. The folding collapsible kick scooter of claim 1 wherein said spring means is a compression spring.

4. The folding collapsible kick scooter of claim 1, wherein said folding structure comprises
a hollow locating frame fixedly connected to the front side of said footplate, said hollow locating frame comprising a first lateral sidewall, a second lateral sidewall opposite to said first lateral sidewall, a rear sidewall, a front sidewall, said front sidewall being shorter than the lateral sidewalls and rear sidewall of said hollow locating frame, two pivot holes respectively disposed at said first lateral sidewall and said second lateral sidewall, a screw hole disposed at said first lateral sidewall;
a coupling frame, said coupling frame comprising a head tube coupled to said handlebar and front fork assembly, and a hollow coupling bar shaped like a channel bar and obliquely downwardly extended from the periphery of said head tube and coupled to said hollow locating frame, said hollow coupling bar comprising two longitudinal sliding slots respectively disposed at two opposite sidewalls thereof, and a locating hole disposed at one sidewall thereof;
a headed pivot pin inserted through the pivot holes of said hollow locating frame and the sliding slots of said hollow coupling bar to pivotally secure said hollow coupling bar to said hollow locating frame;
a locking lever pivoted to one end of said pivot pin and turned between a locking position to lock said hollow coupling bar and an unlocking position to unlock said hollow coupling bar;
a barrel fastened to said hollow locating frame, said barrel comprising a threaded neck threaded into the screw hole said hollow locating frame;
a locking rod inserted through said barrel and adapted to alternatively engage the locating hole and one sliding slot of said hollow coupling bar of said coupling frame, said locking rod having an outer thread at an outer end thereof and a flange around the periphery thereof;
a compression spring sleeved onto said locking rod and stopped between the flange of said locking rod and one lateral sidewall of said hollow locating frame; and
a cap nut threaded onto the outer thread said locking rod for pulling by hand to disengage said locking rod from said hollow coupling bar.

5. The folding collapsible kick scooter of claim 4 wherein said front sidewall of said hollow locating frame is a split wall having a longitudinal split.

6. The folding collapsible kick scooter of claim 4 wherein said rear sidewall of said hollow locating frame is a split wall having a longitudinal split.

7. The folding collapsible kick scooter of claim 4 wherein said front sidewall and said rear sidewall of said hollow locating frame are split walls, each having a longitudinal split.

8. The folding collapsible kick scooter of claim 1 wherein said rear brake unit comprises:
a rear wheel bracket fixedly fastened to the rear side of said footplate to support said rear wheel, said rear wheel bracket comprising two pivot holes aligned at two sides, and a recessed hole disposed at one side;
a pivot fastened to the pivot holes of said rear wheel bracket;
a foot brake pivoted to said pivot for pressing by the kick scooter rider to stop said rear wheel from rotation, said foot brake comprising a pedal, a brake shoe extended from said pedal, a transverse pivot hole spaced between said pedal and said brake shoe, which receives said pivot, and a recessed hole disposed at one side; and
spring means mounted on said pivot and connected between the recessed hole of said rear wheel bracket and the recessed hole of said foot brake to hold said foot brake away from the periphery of said rear wheel.
